(19) United States
(12) Patent Application Publication
(10) Pub. No.: US 2024/0067123 A1
(43) Pub. Date: Feb. 29, 2024

(54) ANTI-THEFT SYSTEM AND DEVICE FOR VEHICLES

(71) Applicant: Stephen Carter Mertz, Royal Oak, MI (US)

(72) Inventor: Stephen Carter Mertz, Royal Oak, MI (US)

(21) Appl. No.: 18/210,488

(22) Filed: Jun. 15, 2023

Related U.S. Application Data
(60) Provisional application No. 63/400,637, filed on Aug. 24, 2022.

(51) Int. Cl. B60R 25/042; B60R 25/24

(52) U.S. Cl. CPC B60R 25/042; B60R 25/24

(57) ABSTRACT

A vehicle anti-theft device and method to operate it are disclosed whereby the user may deactivate the flow of energy or fuel to a vehicle motor or engine when the vehicle is operated without authority of the user.

### PRIORITY CLAIM

This application claims priority to U.S. Provisional Patent Application Ser. No. 63/400,637 entitled “Vehicle Anti-Theft Device For Motor Vehicles” filed Aug. 24, 2022, incorporated herein by reference in its entirety.

### TECHNICAL FIELD

The present disclosure relates to an anti-theft device and system for motor vehicles, particularly automobiles, which may be retrofit onto any motor vehicle to interfere with energy delivery to the vehicle motor.

The present disclosure further relates an anti-theft device and system that, in one embodiment, interferes with the delivery of fuel to the vehicle motor, thereby rendering the vehicle inoperable.

The present disclosure further relates to an anti-theft device and system that, in one embodiment, interferes with the electrical energy delivery to a vehicle motor or component thereof, thereby rendering the vehicle inoperable.

The present disclosure further relates to an anti-theft device and system that may be remote activated and deactivated by a vehicle owner to interfere with the delivery of energy to a vehicle motor or component thereof, thereby rendering the vehicle inoperable.

### BACKGROUND

Motor vehicles, either electric or internal combustion engine driven, as subject to theft or “carjacking”. Such vehicle theft is a multi-million-dollar problem for the insurance industry and for law enforcement. Oftentimes, a vehicle is stolen and within a short period of time, disassembled in “chop shops” where the parts are sold on the market. When the stolen vehicle is “chopped” or sold off in pieces, it is nearly impossible to track. This ease in disposal of stolen vehicle parts is a contributing factor in auto theft.

In addition, oftentimes vehicles are stolen and, in a remarkably short time, shipped off to a foreign country for resale. Such vehicles are not recoverable and are not easily traceable, resulting in losses for the insurance industry and the owner of the vehicle. It is an object of the disclosure to provide a simple, reliable, and quick solution to this problem by immediately disrupting the flow of energy or fuel to a vehicle motor or engine that disables the vehicle before the thief can travel any substantial distance in the stolen vehicle.

### SUMMARY

In one embodiment, there is disclosed a system comprised of a remote-control device, such as a key fob, that is activated by an owner when the vehicle is stolen, and a circuit switch inserted into a fuse box on a vehicle. When activated, the key fob sends a signal specific to the vehicle that, in the case of an electric vehicle, activates the circuit switch and interrupts the flow of energy to the motor, rendering the vehicle inoperative.

In another embodiment, there is disclosed a system comprised of a remote-control device, such as a key fob, that is activated by an owner, and a circuit switch or fuse in the fuse box of an internal combustion fuel vehicle that switches the fuel pump off, thereby interfering with the delivery of fuel to the engine and rendering the vehicle inoperable.

In another embodiment, there is disclosed a system comprised of a remote-control device, such as a key fob, that is paired with an anti-theft device. The anti-theft device includes a transceiver that signals the vehicle owner's key fob when a vehicle is operating without permission by the owner. The anti-theft device includes a fuse that is inserted into the vehicle fuse box in place of the fuel pump fuse. When a vehicle is being stolen, a signal is sent by the remote-control device to the key fob which alerts the owner by audio, haptic or visual, such as flashing LED that the car is being stolen. The owner then activates the key fob that sends a signal to the remote-control device on the vehicle. The signal shorts the fuse for the fuel pump, or in the case of an electric vehicle, shorts the electric vehicle's power supply.

### BRIEF DESCRIPTION OF THE DRAWINGS

FIG. 1 is an exploded schematic representation of a Key FOB.

FIG. 2 is a schematic representation of a circuit in the Key FOB showing the CPU with memory and a transmitter or a transceiver.

FIG. 3 is a schematic representation of a vehicle fuse box.

FIG. 4 is a schematic representation of a switch insertable into the fuse box of FIG. 3 to interrupt the flow of energy to fuel to the vehicle motor or engine.

FIG. 5 is a schematic representation of one mode of operation for the anti-theft device of the disclosure.

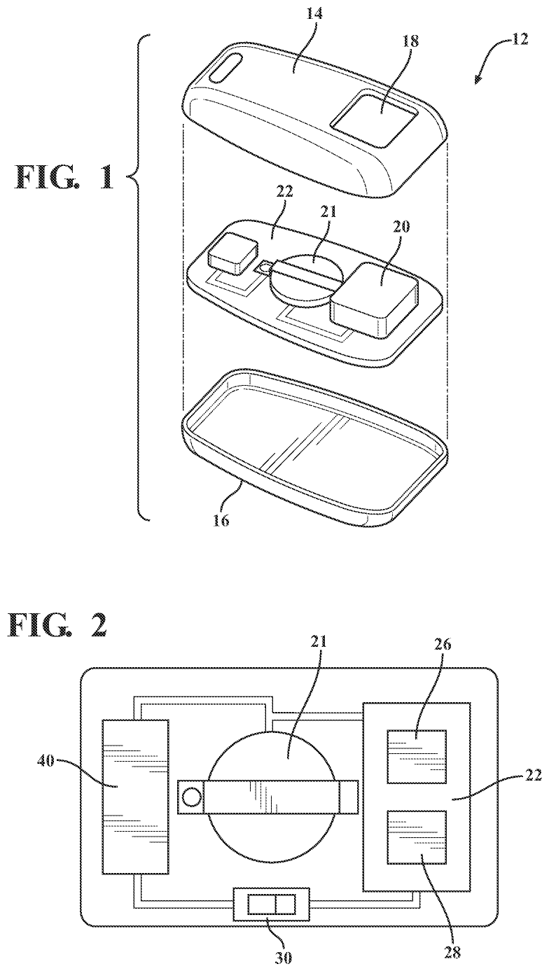

### DETAILED DESCRIPTION

Turning now to the Figures, wherein like numbers refer to like structures, the anti-theft system 10 includes Key FOB 12. Key Fob 12 has a top casing 14 and bottom casing 16 that snap fit together as is known in the art. The top casing has an aperture 18 through which protrudes button 20. Button 20 is mounted on circuit board 22 and acts as a switch to activate the antitheft device. A battery 21 powers the circuit board. Circuit board 22 also includes a CPU 24 that includes a memory 26. The memory has programming or instructions 28 to create a signal that is specific to the vehicle to which it is coupled. The programming may include instructions to create a random or pseudo random alpha-numeric signal or some other random signal so that once the ant-theft device and the key fob are electronically “mated”, the anti-theft device on the vehicle will only respond to the specific key fob. In another embodiment, the key fob and the anti-theft device are electronically coupled by arranging switches 30 on the circuit board so the signal from the key fob is specific to the anti-theft device. The Key Fob further includes a transmitter or transceiver 40, from which signals are transmitted when the Key Fob button is activated, sending a signal to the switch 36.

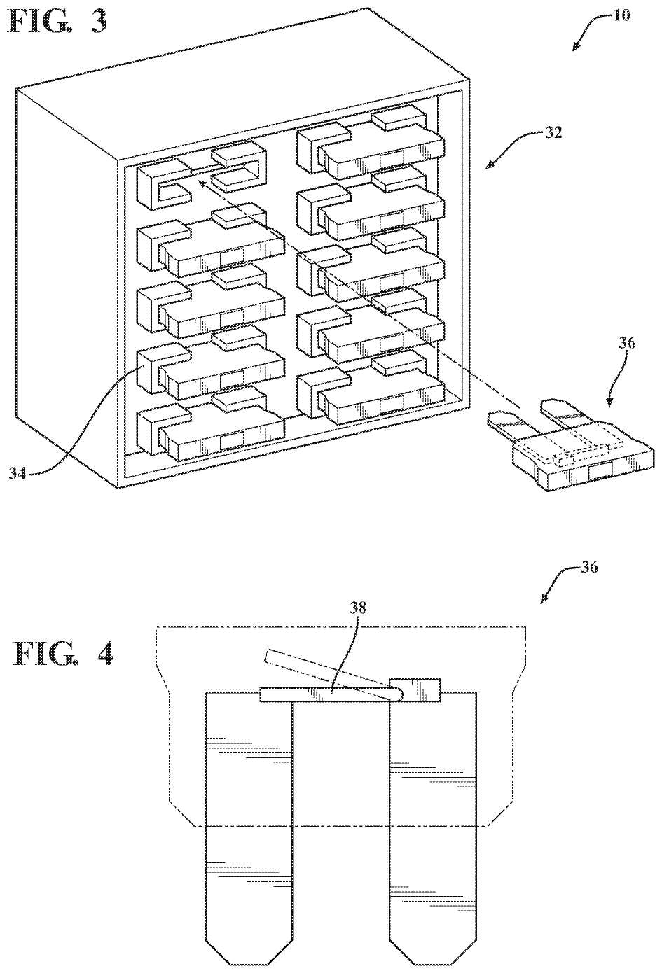

The fuse box 32 in FIG. 3 shows a number of fuses 34 in place controlling the electrical activity of the motor or engine. The switch 36, which may be a fuse, is inserted into the fuse box fuse in place of the fuel pump fuse or, if the vehicle is an electric car, it is inserted in place of the main fuse to the motor. The switch 36 has a switch circuit 38 internal to the fuse that may be opened by activation of the key fob. The switch circuit may include a breaker or it may include a filament that is shorted when the FOB button is activated, thereby incapacitating the fuel pump (in the case of an internal combustion engine) or it may incapacitate the main fuse of an electric vehicle. In addition, the switch may be timed so that it automatically closes to permit operation of the vehicle after the lapse of a predetermined period of time. For example, the switch may automatically close after being opened after the lapse of 5 minutes after activation. This feature may provide more ease of operation as the vehicle owner does not have to carry extra fuses in the event a fuse is used as the switch. In either embodiment, the vehicle travel is stopped well before there is a chance for the thief to get away and chop the vehicle.

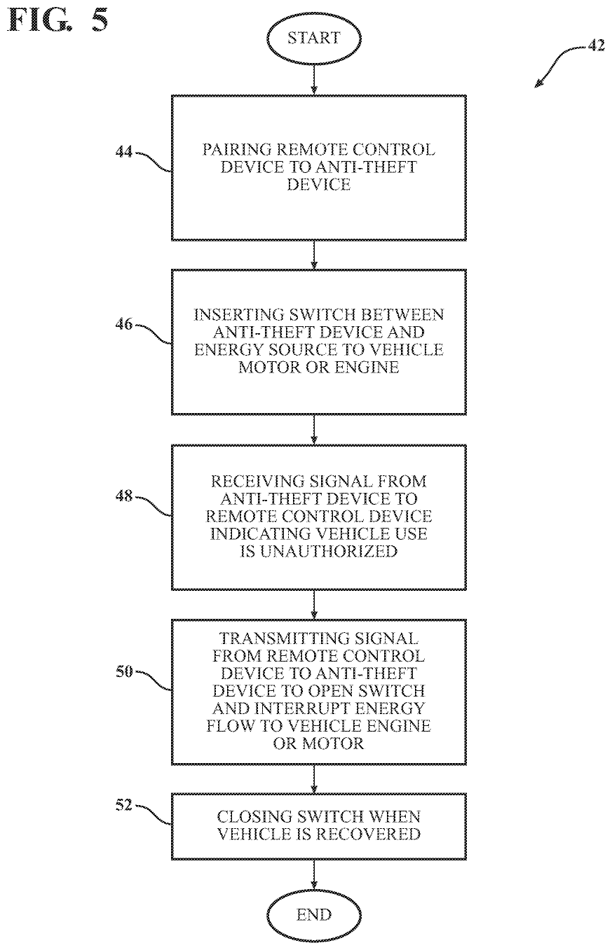

FIG. 5 is a schematic representation of one method 42 of operation for the anti-theft system of the disclosure. Specifically, at step 44, the fob is mated to the device by way of a random or pseudo random alpha-numeric signal or some other random signal. The fob button is depressed and a random alpha-numeric signal or some other random signal is transmitted to the CPU in the anti-theft device. The anti-theft device then transmits a return signal via a transceiver or transmitter back to the fob. This return signal creates a recognition signal, such as a flashing or steady fob light, to indicate the device and the fob are linked. Step 46 is the removal of a fuse from a vehicle fuse box, such as the fuel pump fuse in case of an internal combustion vehicle, or a power fuse to the main circuit of an electric vehicle, and the insertion therefor by a fuse unit 36 on the anti-theft device. The fuse unit on the anti-theft device may have a switch or circuit filament 36 that is easily opened in the case of a switch or “burned out” in the case of a filament upon signal by the fob. When the operator is alerted the vehicle is being stolen, as at step 48 by receipt by the remote device of a signal (which may be audio, haptic or visual, such as a flashing LED) from the anti-theft device that the vehicle is operating without authority of the owner, the operator actuates the fob button, as at step 50, thereby transmitting a signal causing the circuit in the fuse unit on the antitheft device to open or to burn out, thereby causing the vehicle to cease operation, either by interrupting the flow of fuel by incapacitating the fuel pump in the case of an internal combustion engine, or by interrupting the flow of electricity in the case of an electric vehicle. In either case, the vehicle is rendered inoperable and may be recovered before it is “chopped” at an illegal parts garage or sold on the foreign markets. When the inoperable vehicle is recovered by the owner, it may be rendered operable wither by replacing the fuse that was burned out or shorted, or by activating the remote control and resetting the open switch, as at step 52.

It is intended that the scope of the present methods and apparatuses be defined by the following claims. However, it must be understood that the disclosed systems and methods may be practiced otherwise than is specifically explained and illustrated without departing from its spirit or scope. It should be understood by those skilled in the art that various alternatives to the configurations described herein may be employed in practicing the claims without departing from the spirit and scope as defined in the following claims. The scope of the disclosed systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc., should be read to recite one or more of the indicated elements unless a claim recites an explicit limitation to the contrary.

It is intended that the following claims define the scope of the device and that the method and apparatus within the scope of these claims and their equivalents be covered thereby. In sum, it should be understood that the device is capable of modification and variation and is limited only by the following claims.

I claim:

1. A vehicle antitheft device, comprising;
a transmitter, said transmitter generating a vehicle deactivating signal; and
a switch to receive the vehicle deactivation signal, said switch activated by said signal to interrupt the flow of energy to a vehicle motor or engine.

2. The vehicle anti-theft device of claim 1, wherein the vehicle is an internal combustion vehicle having an electric fuel pump.

3. The vehicle anti-theft device of claim 1, wherein said vehicle is an electric vehicle.

4. The vehicle anti-theft device of claim 1, wherein said switch is a fuse.

5. A vehicle anti-theft system, comprising a remote-control device electronically paired with an anti-theft device; said anti-theft device including a transceiver that signals the remote control device when a vehicle is operating without owner permission; said anti-theft device further including a switch to interrupt the transmission of energy to the vehicle engine or motor, said remote control device capable of transmitting a signal to the anti-theft device that opens the switch and interrupts the supply of energy to a vehicle engine or motor.

6. The vehicle anti-theft device of claim 5, wherein the vehicle is an electric vehicle, and the switch interrupts the flow of electric energy from a battery to the vehicle motor.

7. The vehicle anti-theft system of claim 5, wherein the anti-theft device transmits a signal to the remote-control device which creates an audio, haptic or visual signal when the vehicle is being stolen.

8. The vehicle anti-theft system of claim 5, wherein the vehicle is an internal combustion vehicle, and the switch is a fuse insertable in a vehicle fuse box to interrupt the flow of energy to a fuel pump.

9. The vehicle anti-theft device of claim 5, wherein the remote-control device is an electronic key fob.

10. The vehicle anti-theft device of claim 5, wherein said switch automatically closes after a predetermined period of time after activation.

11. A method to operate a vehicle anti-theft system, comprising:
pairing an anti-theft device with an electronic remote-control device; said anti-theft device capable of transmitting a signal to the remote control device;
inserting a switch between a vehicle motor or engine and said vehicles source of energy; said switch activatable by a signal from said remote control device;
activating the remote-control device to send a signal to the anti-theft device, said signal causing the switch on the anti-theft device to open or to burn out, thereby interrupting the flow of energy to the vehicle motor or engine.
